(19) United States
(12) Patent Application Publication
(10) Pub. No.: US 2015/0159051 A1
(43) Pub. Date: Jun. 11, 2015

(54) CATALYSIS OF SILANE-CROSSLINKABLE POLYMER COMPOSITION

(71) Applicants: Henkel AG & Co. KGaA, Duesseldorf (DE); Dow Europe GmbH, Horgen (CH)

(72) Inventors: Matthias Kohl, Weinheim (DE); Manfred Proebster, Nussloch (DE); Renjie Ge, Nanjing (CN); Manfred Etzelstorfer, Buchs SG (CH); Cord Manegold, Moos (DE)

(21) Appl. No.: 14/624,653

(22) Filed: Feb. 18, 2015

Related U.S. Application Data
(63) Continuation of application No. PCT/EP2013/067444, filed on Aug. 22, 2013.

(30) Foreign Application Priority Data
Aug. 24, 2012 (EP) 12181689.6

(51) Int. Cl. C09J 4/00; C09D 4/00; C08K 11/00

(52) U.S. Cl. CPC C09J 4/00; C08K 11/00; C09D 4/00

(57) ABSTRACT

Moisture-hardening 1-component or 2-component composition that contains at least one prepolymer with at least one hydrolysable silane group, chosen from silane-modified polyoxyalkenes, polyolefins, poly(meth)acrylates, polyurethanes, polyamides or polysiloxanes, a Sn-based catalyst and optionally adjuvants and additives, wherein the catalyst is selected from tetramethyl-stannoxy dicarboxylates.

The invention concerns pasty or flowably applicable one- or two-component adhesives, sealants or coatings based on silane-functionalized prepolymers that can be crosslinked by moisture, comprising particular tin (Sn) catalysts.

Moisture-hardening elastic adhesives and sealants are used in many areas of industry. It is desirable here that it be possible for these gluings to be performed on different substrates, without requiring pretreatment with a primer or by physical methods. Such adhesives and sealants based on silane-crosslinking prepolymers are known. They require water for crosslinking and a catalyst to accelerate the reaction.

Heavy metal catalysts are known, but amine catalysts may also be used. However, in some cases they are dangerous from a health point of view, in particular during processing. So they should be replaced by other, less critical catalysts. However, sufficient reactivity acceleration is a requirement.

DE 102004022150 discloses two part adhesive/sealant compositions based on silane-substituted polyethers. They include as silane crosslinking catalyst Sn(II) or Sn(IV) salts or amines.

EP 1303569 discloses polymers that carry at least two Si(OR)-groups on a polymer skeleton. The compounding agents can be introduced in adhesives, paints or foam precursors. The catalysts described are the known Sn, Bi, or Zr catalysts.

EP 2089490 discloses single component adhesive and sealing compounds that consist of a silane-functional polyoxyalkene prepolymer and a silane-functional polyolefin. Various additives are added to this mass, for example the known Sn catalysts.

From US 2007287787 A1 hybrid adhesives are known comprising a silane resin and an epoxy resin, as well as particular amines and at least one silane catalyst which is not an amine compound. A wide variety of suitable silane catalysts is disclosed, including organotin compounds as the preferred catalyst group. Several octyltin and butyltin compounds are mentioned as being particularly preferred.

U.S. Pat. No. 3,664,997 A relates to curable room temperature organopolysiloxanes comprising an organopolysiloxane and a specific organotin compound. The organotin compound may be a mono- or binuclear compound bearing a variety of substituents on the tin atoms. Tetramethyl-stannoxy dicarboxylates are not mentioned.

FR 2864096 A1 discloses one component organopolysiloxane compositions comprising a crosslinking catalyst. Again, mono- and binuclear tin compounds are mentioned. The preferred tin compounds comprise dibutylcarboxylatotin-moieties.

EP 345447 A2 deals with certain bissilyl ureas that have been found useful as adhesion promotors for silicone latex compositions. These compositions are based on specific silanol-terminated polydiorganosiloxanes and further comprise inter alia a tin catalyst. The preferred tin catalysts are stannoxanes but there is no disclosure of tetramethyl-stannoxy dicarboxylates.

EP 1806379 A1 discloses tetrabutyl-stannoxy dilaurate as useful condensation catalyst for polyethylene polymers bearing grafted silane groups.

Adhesives based on polymers bearing crosslinkable silane groups usually require catalysts to achieve a fast-crosslinking reaction. Catalyst-free systems react more slowly. Usually the desired fast hardening rate is accomplished by adding tetravalent dibutyltin compounds. However, they are toxic and subject to legal restrictions. Such tin compounds have the additional disadvantage of being able to migrate out of the crosslinked compositions, which leads to contamination of the product surface with increasing metal salt concentrations. The latter can then also be washed out into the environment. Alternative tin catalysts known from the prior art usually do not show the activity of tetravalent dibutyltin compounds and/or show other disadvantages.

It is therefore the object of the invention to provide compositions useful as adhesives, sealants and coatings based on polymers with hydrolysable silane groups which can be crosslinked in the presence of water but not requiring addition of the conventionally used catalysts. Catalysts used in such composition should show reduced toxicity compared to the widely used tetravalent dibutyltin compounds but need to be sufficiently active. Moreover, the catalyst should also be less able to migrate out of the crosslinked adhesives or sealants. The compositions should allow formulation as single-component (1C) or two-component (2C) composition.

The task is accomplished by means of a composition that contains a) at least one prepolymer containing at least one hydrolysable silane group, selected from silane-modified polyoxyalkylenes, polyolefins, poly(meth)acrylates, polyurethanes, polyamides, or polysiloxanes, b) at least one Sn-based catalyst selected from tetramethyl-stannoxy dicarboxylates and c) optionally further adjuvants.

The term adjuvant is intended to refer to active ingredients like further catalysts, softeners or stabilizers as well as to more inert ingredients like fillers or pigments. The terms adjuvant and additive have the same meaning with regard to this application and may be used interchangeably.

The compositions according to the invention are moisture curable compositions. They can be manufactured as one component (1C) or two component (2C) compositions. They can be used inter alia as adhesives, sealants, filling compounds or coating agents. The various application compositions differ in their physical parameters, such as viscosity, stability or mode of application, such as thin layers, flexible beads or adhering layers. The properties can be adjusted by additives; however, important parameters for the application properties are structure, molecular weight, and composition of the polymer, as well as the viscosity of the composition. In accordance with the invention it is necessary for the composition to contain at least one reactive prepolymer that can be crosslinked by silane groups being selected from silane-modified polyoxyalkylenes, silane-modified polyolefins, silane-modified poly(meth)acrylates, silane-modified polyurethanes, silane-modified polyamides, and polysiloxanes.

The crosslinkable prepolymers may be built of known polymers as backbone that contain a number of reactive silane groups from their synthesis, or that can be subsequently modified with reactive silane groups. The base polymers are not crosslinked, in particular linear or slightly branched polymers, such as polyoxyalkylenes, polyolefins, poly(meth)acrylates, polyurethanes, polyamides, or also polysiloxanes. They must contain at least one, preferably at least two hydrolysable silane groups.

One group suitable as base polymers is based on polyacrylates that contain at least one hydrolysable silane group on the polymer chain. The poly(meth)acrylates suitable according to the invention are for example polymerization products of one or several acrylic acid esters, alkylacrylic acid esters or alkyl(meth)acrylic acid esters of alcohols having 1 to 18 carbon atoms. Some (meth)acrylic acid or other copolymerisable monomers—for example styrene, vinyl esters, acrylamide—may also be present. C₁₋₁₂-alkyl(meth)acrylates are particularly suitable. The man skilled in the art knows such polymers, which can be manufactured in different processes. They are also commercially available in various chemical compositions.

The silane groups may be bound to the basic polymer skeleton by various chemical reactions. It is for example possible to incorporate silanes that contain an unsaturated rest and hydrolysable groups into the backbone via copolymerization. In this case the silane groups will be randomly distributed within the polymer chain, or block polymers are obtained.

Another method to incorporate silane groups starts from acrylate polymers containing unsaturated groups, subsequently reacting the unsaturated double bonds with silanes by hydrosilylation. In this case it is also possible to obtain such unsaturated groups and hence, the silane groups, at the terminal position of the (meth)acrylate polymer.

By another manufacturing process the silane groups are reacted onto the base polymer by means of polymer-analogue reactions. For example, OH groups (hydroxyl groups) can be reacted with diisocyanates; these can then be reacted with silane compounds that in addition have a nucleophilic group to form suitably functionalized prepolymers.

Polyolefins are another group of suitable base polymers. They can also be modified with silane groups on the polymer. As already described in general, such functional groups can be introduced by copolymerization, but can also be reacted to the chain by means of polymer-like reactions. Furthermore, graft reactions with silane group-containing compounds are also possible.

Another group of suitable prepolymers are those based of polyethers (polyoxyalkylenes). A wide variety of polyethers is generally known, for example polyethylene oxides, polypropylene oxides, poly-THF, and random or blockcopolymers based on mixtures of different alkyleneoxide units. Particularly suitable are di- or trifunctional polyethers based on polypropylene glycol or polyethylene glycol.

For polyethers different processes are known to insert silane groups into the base polymer. According to one method polyether polyols are reacted with diisocyanates to NCO-containing polymers in a first step. These are subsequently reacted with nucleophilically substituted silanes, for example amino-functional, hydroxyl-functional, or mercapto-functional silanes. The amount is chosen in such a way that all NCO groups are reacted. Another possibility is the reaction of hydroxyl-functional polyethers with isocyanate-functional silanes.

In another method, first polyethers with unsaturated double bonds are manufactured that are subsequently reacted by hydrosilylation with compounds that have at least one silane group. So these hydrolysable silane groups are chemically bound to the polymer chain. In another process polyethers containing olefinically unsaturated groups are reacted with a mercapto-silane, for example 3-mercaptopropyl-trialkoxy-silane to form chemically bound silane groups.

Polyether prepolymers suitable according to the invention with a sufficient number of silane groups are commercially available with different molecular weights and chain structures.

Hydrolysable silane group-containing polymers can also be manufactured from polyester-polyols, polyurethane-polyols or polyamides. For this manufacturing process existing functional groups of the polymer chain—such as OH—, NH— or COOH groups—are reacted with compounds that contain a silane group and a group reactive toward the functional group of the polymer. By means of the amount and choice of these compounds the number of silane groups on the polymer chain can be adjusted.

Another group of suitable base polymers are polysiloxanes, which contain —[SiR₃R₄—O]— units as chain. Here, the substituents R₃ and R₄ can be the same or different, for example C₁₋₆-alkyl or alkoxy groups. Suitable polysiloxanes must also include groups crosslinkable by hydrolysis. Such polysiloxanes are known to the man skilled in the art in various structures and compositions. Such polymers also include polysiloxane block copolymers with other polymer building blocks.

In general, such prepolymers are suitable that contain chemically bound hydrolysable silane groups of the formula

P—Si R¹ₘ R²ₙ

wherein
P represents a polymer chain,
R¹ is a linear or branched, substituted or unsubstituted alkyl group with 1-8 C atoms,
R² is an alkoxy group with 1-4 C atoms, or an acyloxy group with 1-4 C atoms,
m=0-2 and
n=3−m, preferably 2 or 3.

Suitable polymer chains are those described above as base polymers. The number of silane groups shall be at least one per polymer chain, but in particular on the average 2 to 10 groups are contained per polymer molecule. In a preferred embodiment the silane groups are terminally groups of the polymer chain. In particular, methoxy-, ethoxy-, propoxy-silanes or acetoxy-silanes are preferred. Suitably functionalized prepolymers are in general known.

In a preferred embodiment of the composition according to the invention, the molecular weight (number average molecular weight MN, to be determined by GPC) of the prepolymers is 1,500-75,000 g/mol; as preferred molecular weight 2,000-50,000 g/mol is suitable, most preferred the range is from 3,000 to 30,000 g/mol. (Meth)acrylate or polyether prepolymers are particularly preferred. Most especially preferred the composition shall contain prepolymers having a polydispersity D (measured as M_{W}/M_{N}) of <2, preferably <1.5.

The composition according to the invention may furthermore contain adjuvants (additives). They can for example be plasticizer, stabilizers, antioxidants, fillers, diluting agents or reactive diluents, drying agents, adhesion promoters and UV stabilizers, fungicides, flame-protecting agents, pigments, rheological adjuvants, colored pigments or colored pastes.

Suitable liquid plasticizers include white oils, naphthenic mineral oils, polypropylene-, polybutene-, polisorprene-oligomers, hydrogenated polyisoprene- and/or polybutadiene oligomers, benzoate esters, phthalates, adipates, citrates, liquid polyesters, glycerin esters, vegetable or animal oils and their derivatives. Hydrogenated plasticizers are for example chosen from the group of paraffinic hydrocarbon oils. Also suitable are polyprolylene glycols and polybutylene glycols, as well as polymethylene glycols. Another class of suitable plasticizers is that based on sulfonic acid esters or -amides. These can be esters of alkylated sulfonic acids. Also polyether- or acrylate-modified polysiloxanes can be used as plasticizers.

Stabilizers encompass antioxidants, UV stabilizers and hydrolysis stabilizers. There are no particular restrictions regarding this kind of adjuvants as long as the properties of the composition before and after crosslinking are not adversely affected. Some examples of suitable stabilizers are the commercially available sterically hindered phenols and/or thioethers and/or substituted benzotriazoles and/or amines of the HALS (Hindered Amine Light Stabilizer) type. In the context of the present invention it is also possible to use a UV stabilizer that carries a silyl group and is incorporated into the end product during crosslinking or hardening. Furthermore, it is possible to add benzotriazoles, benzophenones and/or sterically hindered phenols. The composition according to the invention may contain up to about 3 wt.-%, preferably about 2 wt.-% stabilizers, based on the total weight of the composition. If several stabilizers are used the given amounts refer to the sum of all stabilizers.

The composition according to the invention may also contain adhesion promoters if required. These can be reactive substances being able to react with the substrate surface, or substances that increase the stickiness on the substrate. The adhesion promoters preferably used are organofunctional silanes and hydroxyfunctional, (meth)-acrylofunctional, mercaptofunctional, aminofunctional or epoxyfunctional silanes. They may also be built into the polymer network. In addition, condensates of for example aminosilanes or other silanes may be used as adhesion promoters. It is also possible to use as adhesion promoters four- or sixfold coordinated alkyl-titanates such as tetraalkyl-titanate, diisobutoxy-bis-ethylacetato-titanate (IBAY) or diisopropoxy-bis-ethylacetato-titanate (PITA). Such adhesion promoters are known from the literature. They are preferably used in amounts of 0.1-5 wt.-%, based on the total weight of the composition. If several of these adjuvants are used the given amounts refer to the sum of all such adjuvants.

Tackifying resins such as modified or unmodified colophonic acids or esters, rosins, polyamines, polyamino-amides, anhydrides and anhydride-containing copolymers or polyepoxide resins in small amounts are equally used to improve the adhesion. Typical tackifiers are usually used in amounts of 5-20 wt.-%.

Suitable drying agents or additional crosslinking agents are in particular hydrolysable silane compounds, for example alkyl-trialkoxy silane, vinyl-trialkoxysilane or tetraalkoxy silane. Such components provide crosslinked adhesives with higher crosslinking density. As a result, after crosslinking the products obtained have a higher module and higher hardness. Such properties can be adjusted by means of the amount used.

Suitable fillers or pigments can be selected from a variety of materials. Examples include chalk, lime powder, precipitated and/or pyrogenic silicic acid, zeolites, bentonites, Mg carbonate, diatomaceous earth, clay, talcum, baryte, Ti oxide, Fe oxide, Zn oxide, sand, quartz, flintstone, mica, graphite, carbon black, Al powder, glass powder or glass fibers and other milled minerals. Pyrogenic silicic acids or bentone are also suitable. In addition, organic fillers can be used, in particular wood fibers, wood flour, saw dust, pulp, cotton, or plastic fibers. Optionally, it can be appropriate for at least part of the fillers to be surface-pretreated. This may lead to better compatibility with the components or to improved moisture stability. Furthermore, hollow beads with a mineral shell (such as hollow glass beads), or a plastic shell, are suitable as fillers. The fillers/pigments are preferably of a particle size of 500 μm or less. The total fraction of pigments and fillers in the formulation preferably varies between 5 and 65 wt.-%, in particular between 20 and 60 wt.-%, based on the total weight of the composition. If several of these adjuvants are used the given amounts refer to the sum of all such adjuvants.

If transparent or translucent compositions are desired, it is preferred that the compositions contain practically no pigments or fillers, i.e. the total amount of pigments and fillers in the formulation is below 1 wt.-%, in particular below 0.1 wt.-%, particularly preferred below 0.01 wt.-%.

The composition in accordance with the invention contains at least one Sn-based catalyst selected from tetramethyl-stannoxy dicarboxylates. Such catalyst is able to catalyze the hydrolytic cleavage of the hydrolysable silane groups and the subsequent condensation of the Si—OH groups to —Si—O—Si— bonds, and shows remarkably high activity. The tetramethyl-stannoxy dicarboxylate catalysts used are multinuclear Sn components. Although some multinuclear Sn compounds are known as useful catalysts for crosslinking hydrolysable silane groups, such compounds do not bear methyl groups bonded to the tin atoms. From the mononuclear tin catalysts it is known, that replacement of butyl groups by methyl groups results in deterioration of the catalytic activity. This is also apparent from the examples given below. Surprisingly, this is not true with regard to the multinuclear tetramethyl-stannoxy dicarboxylates.

As carboxylate groups of the tetramethyl-stannoxy dicarboxylates C₂₋₂₀ -carboxylate groups are preferred. More preferred are C₈₋₁₈ -carboxylate groups. Equal or different carboxylate groups may be present in the compound. Particularly preferred tetramethyl-stannoxy dicarboxylates are tetramethyl-stannoxy dilaurate, tetramethyl-stannoxy dioleate, and mixtures thereof.

The tetramethyl-stannoxy dicarboxylates are used in amounts of about 0.01-5 wt.-%, relative to the total weight of the composition, preferably in amounts of 0.1-4 wt.-%. In case several tetramethyl-stannoxy dicarboxylates are present the given amounts refer to the sum of all such compounds.

It is also possible to include co-catalysts in addition to the tetramethyl-stannoxy dicarboxylates, as long as they are not hazardous to health. Examples include titanates, bismuth compounds, organoaluminum compounds, and in particular amine, amidine and guanidine compounds, preferably non-volatile amine compounds, such as diethylene triamine, triethylene tetramine, triethylene diamine, morpholine, and N-methyl-morpholine, amidine compounds such as 1,8-diazabicyclo-(5,4,0)-7-undecene (DBU), diazabicyclo-octane (DABCO), and diazabicyclo-nonene (DBN), and guanidine.

Preferably, besides the tetramethyl-stannoxy dicarboxylates, there are no further tin compounds present in the composition.

The composition according to the invention can be prepared by simply mixing the components. It is advantageous to mix the components at increased temperatures, to obtain a more readily flowable composition. It is possible to carry out the mixing and dispersion batchwise, on known aggregates. It is also possible to manufacture the composition continuously in an extruder. The sequence of addition and mixing steps depends on the viscosity, consistency and amount of the individual components. Any solids should be uniformly dispersed in liquid constituents. The mixing step shall ensure the stability of the composition and avoid a phase separation during storage. It may be appropriate to dry individual components to ensure high storage stability. In principle the manufacturing process is known and can be readily determined by the man skilled in the art, depending on the choice of raw materials.

The compositions according to the invention may be liquid, or thixotropic or non-sagging products. They may be prepared as 1C or 2C compositions. The compositions as discussed above can be used directly as 1C compositions.

One embodiment are 1C compositions that are highly viscous or solid at room temperature, for example having a viscosity of 200 Pas (EN ISO 2555, 25° C.). For application such composition can be heated to temperatures of 30-80° C. to become flowable, and can be applied in this form. Another embodiment are 1C compositions that are liquid at room temperature, for example with a viscosity below 20,000 mPas (25 ° C.). They can be pumped when the viscosity is low, or also poured. These compositions are moisture-crosslinkable, the moisture coming from the environment after application.

When 2C compositions are prepared, the composition as disclosed above can be used as one of the components (component A), i.e. component A already comprises the prepolymer and the catalyst. An additional component B is prepared and stored separately from component A and is admixed only shortly prior to application.

It is also possible, that the composition is a 2 C composition, comprising a first component A and a second component B, wherein said component A contains the at least one prepolymer with hydrolysable silane groups, and said component B contains the catalyst and in addition at least one compound selected from the group consisting of water, water-absorbing fillers, other silane-crosslinking prepolymers and/or monomeric silane compounds.

In each case component B comprises preferably ingredients that can be crosslinked with the silane groups of the prepolymers. For example, silane-crosslinkable polymers are suitable containing at least two reactive groups able to react with the silane groups of the prepolymer in component A. For example, the prepolymers with silane groups as mentioned above are suitable. Also monomeric or oligomeric silane compounds may be present, for example with low molecular weight of less than 500 g/mol. However, preferably component B contains water as crosslinking agent. In order to achieve good miscibility of component B with component A, to improve the storage stability of component B and to improve the crosslinking, component B preferably contains polymers and additives that can dissolve or absorb water. Preferably, component B is flowable.

Suitable polymers and additives that can dissolve or absorb water are for example polar liquids, for example hygroscopic liquids, and fillers with a high absorption capacity for water. Inorganic or organic thickeners are also suitable. In addition it is possible that the water may react in part with silane compounds to silanol groups in this component B.

Component B may further comprise thickeners, for example water-soluble or water-swellable polymers, or inorganic thickeners. Examples for organic natural thickeners include agar-agar, carrageen, tragacanth, gum Arabic, alginates, pectines, polysaccharides, guar meal, starch, dextrines, gelatins, casein. Examples of organic fully or partially synthetic thickeners include poly(met)acrylic acid derivatives, carboxymethyl-cellulose, cellulose ethers, hydroxyethyl-cellulose, hydroxypropyl-cellulose, polyvinyl ether, polyvinyl alcohol, polyamides, polyimines. Examples of inorganic thickeners or fillers include polysilicic acids, highly disperse, pyrogenic, hydrophilic silicic acids, clay minerals such as montmorillonite, kaolinite, halloysite, Al hydroxide, Al oxihydrate, Al silicate, talcum, quartz minerals, chalk, Mg hydroxide or molecular sieves of various pore sizes. Another embodiment uses hydrophilic polyols, for example glycerin, or low-molecular polyethylene glycols. Mixtures of different water-carrying compounds may also be present.

Component B is preferably liquid or pasty. The preferred viscosity is 5,000-800,000 mPas (25° C.), in particular up to 100,000 mPas.

The constituents of the individual components are chosen so that the necessary weight ratio of A:B to arrive at the desired composition is between 1:1 and 10:0.1. This ensures that the mixing ratio can be easily measured.

In one preferred embodiment the composition is a 1C composition, containing 5-65 wt.-% of one or several of the prepolymers with 2-10 silane groups, 5-65 wt.-% of at least one pigment and/or filler, 0.01-25 wt.-% adjuvants and additives and 0.01-5 wt.-% of at least one tetranmethyl-stannoxy dicarboxylate, wherein the sum should amount to 100 wt.-%. Preferably 10-40 wt.-% prepolymers and 20-60 wt.-% pigments and/or fillers are contained in the composition. Another embodiment contains up to 75 wt.-% prepolymers and is essentially free of fillers and pigments. In yet another embodiment the composition further comprises at least on of the above mentioned co-catalysts, preferably selected from amines, amidines or guanidine compounds, in amounts of 0.1-2 wt.-%. Particularly suitable prepolymers are in particular those based on polyethers or poly(meth)acrylates. If the composition is a 2C composition, preferably the just mentioned 1C compositions are used as component A.

Preferred components B contain optionally 0-30 wt.-% of one or several silane groups-containing compounds, for example prepolymers and/or low-molecular silane compounds; 2-60 wt.-% of one or several solid, water-absorbing substances, preferably thickeners, fillers or molecular sieves; 10-60 wt.-% adjuvant and additive, in particular catalysts, hygroscopic solvents and/or softeners, and 0.5-15 wt.-% water. The total of all constituents of component B should add to 100 wt.-%.

The compositions according to the invention can be used in various application fields. They can be used for example to manufacture elastic seals, as or to manufacture adhesives and coating agents; and as or to manufacture potting compounds.

According to one embodiment the compositions according to the invention are applied in liquid form and crosslink under the action of moisture. Another embodiment operates with compositions essentially solid at room temperature. They are applied in molten form and after cooling provide initial adhesion of the substrates to be bonded. Additionally they will crosslink with water thereafter.

A high crosslinking speed is obtained by means of the selection of catalysts according to the invention. It was furthermore found that these particular multinuclear Sn catalysts can be incorporated stable into the polymer matrix. Diffusion in the crosslinked polymer matrix is slow.

The catalysts used according to the invention are less environment-damaging than those known. In addition, due to the low migration capacity of these catalysts, also their enrichment on the surface of the crosslinked composition is prevented. Thus, possible skin contact in certain application areas—such as sealing composition—is reduced.

The compositions according to the invention can for example be used as adhesives to bond various substrates. For example, rigid substrates such as glass, metals, aluminum, steel, ceramics, plastics and wooden substrates—optionally also painted surfaces or other coated surfaces—can be bonded together. In addition, also flexible substrates such as plastic sheets, metal foils or elastomeric films can be glued together, or to other rigid substrates. Full-surface bonding can be achieved; it is also possible to apply a band of the adhesive to the edge of rigid substrates, so that another substrate can be glued onto a limited area. It is also possible to apply the adhesive as thick layer, up to 15 mm, having adhesive and sealant properties.

Another implementation form uses the compositions as a sealant. In this case pasty compositions are usually prepared, which can be applied using cartridges or similar means of application. After application the sealants will crosslink under the action of humidity.

A further application form of the invention is its use as coating agent. It can be applied unilaterally on the substrates in a layer thickness of 0.1-5 mm. These layers will crosslink to elastic coatings.

The crosslinked compositions according to the invention are highly temperature resistant, light resistant and weathering resistant. Even after prolonged UV irradiation or humidity stress there is no degradation of the polymers of the composition. Adhesion to the substrate remains stable. An additional advantage is the high flexibility of the crosslinked products. The adhesives/sealants remain elastic even at raised temperatures under outside weathering of the bonded substrates. A thermal expansion of the substrates does not lead to rupture of the adhesion.

By the selection of the catalysts according to the invention compositions crosslinkable by silane groups are obtained, that will crosslink rapidly and thus provide fast processing. In terms of industrial hygiene, compositions are obtained that have good property profiles and contain reduced amounts of hazardous substances.

The compositions can be used in many technology fields. For example they can be used in the construction area, as construction adhesive, e.g. for components such as windows, or for ceramic parts, or to glue flexible sheet materials to rigid substrates. As further application fields may be mentioned the transport industry, and the machine-, apparatus- and plant construction. Special application areas include elastic bonding in photovoltaics, wind craft plants and in the electronics industry.

A further object of this invention is the use of a tetramethyl-stannoxy dicarboxylate as a catalyst for crosslinking silane-hardening compositions selected from one component and two component adhesives, sealants and coatings, preferably for the compositions described above.

### EXAMPLES

Catalyst 1: Tetramethyl-stannoxy dioleate
Catalyst 2: Tetramethyl-stannoxy dilaurate
Catalyst 3: DBTL (Dibutyltin dilaurate)—comparison
Catalyst 4: Dimethyltin dipalmetate—comparison
Catalyst 5: Dimethyltin dilaurate—comparison

Catalyst 6: Dimethyltin bis (2-neodecanoate)—comparison
Silane-modified prepolymer: liquid polypropylene glycol bis-(methyldimethoxysilylpropyl) ether, about 2 functional, molecular weight (MN) about 22,000 g/mol

### Component A

| | Example 1 | Example 2 | |
|---|---|---|---|
| Silane- | 33.0 | 30.0 | Silane-terminated poly- |
| modified | | | ether prepolymer |
| prepolymer | | | |
| Softener | 8.5 | — | Mesamoll |
| Softener | — | 13.4 | DIDP |
| Rheology | 2.0 | 4.0 | |
| adjuvant | | | |
| Ti dioxide | 6.0 | 4.0 | |
| Chalk | 45.6 | — | Precipitated, coated |
| | | | chalk |
| Chalk | — | 46 | grounded chalk |
| Light- | 1.2 | 1.2 | Tinuvin 770 |
| protecting | | | |
| agent | | | |
| Drying agent | 1.5 | — | Alkoxy-silane |
| Adhesion | 1.6 | 1.2 | Amino-silane |
| promoter | | | |
| Catalyst | as specified in | as specified in | |
| | tables 1 and 2 | tables 1 and 2 | |

### Component B

| | | |
|---|---|---|
| Softener | 51 | Acclaim 6300 |
| 10% tylose solution | 10 | |
| Chalk | 39 | coated |

(amount indications in parts by weight)

Both components are viscous/liquid components.
1C: Component A according to examples 1 and 2 is directly applied
2C: Component A according to examples 1 and 2 is mixed with component B before application, weight ratio A:B=10:1

The starting materials of the compositions are mixed and degassed. Pasty sealant or adhesive compositions are obtained.

Test specimens are prepared form these compositions and evaluated.

The tables below show the effect of different catalysts.

TABLE 1
Example 1

| | Skin formation | | Open time | | |
|---|---|---|---|---|---|
| | 1C | Crosslinking | 2C | | Odor |
| 0.4% catalyst 3 | approx. 20 | crosslinked, | 40 | min | none |
| | min | elastic | | | |
| 0.5% catalyst 1 | 75 min | crosslinked, | 150 | min | none |
| | | elastic | | | |
| 1.0% catalyst 1 | 120 min | crosslinked, | 90 | min | none |
| | | elastic | | | |
| 2.0% catalyst 1 | 60 min | crosslinked, | 90 | min | none |
| | | elastic | | | |
| 0.5% catalyst 2 | 33 min | crosslinked, | 30 | min | none |
| | | elastic | | | |
| 2% catalyst 2 | 29 min | crosslinked, | 25 | min | none |
| | | elastic | | | |
| 1% catalyst 4 | 21 min | not crosslinked | >7 | days | none |
| | | non elastic | | | |
| 1% catalyst 5 | 20 min | not crosslinked | >7 | days | none |
| | | non elastic | | | |
| 1% catalyst 6 | 21 min | crosslinked, | 24 | hours | none |

elastic

(% is % by weight)

TABLE 2
Example 2

| | Skin formation | | Open time | |
|---|---|---|---|---|
| | 1C | Crosslinking | 2C | Odor |
| 0.2% catalyst 3 | approx. 30 | crosslinked, | 60 min | none |
| | min | elastic | | |
| 0.2% catalyst 1 | approx. 110 | crosslinked, | 240 min | none |
| | min | elastic | | |
| 0.2% catalyst 2 | approx. 40 | crosslinked, | 60 min | none |
| | min | elastic | | |

(% is % by weight)

The time until skin forms on the sample surface is determined.

The open time is determined until the composition can still be processed, i.e. the masses are not gel-like.

As obvious from the tables above tetramethyl-stannoxy dicarboxylates (catalysts 1 and 2) show a good catalytic effect, comparable to the widely used mononuclear catalyst DBTL (catalyst 3). After 24 h all masses were crosslinked.

In contrast, mononuclear dimethyltin dicarboxylates (catalysts 4 to 6) do not show the required activity.

What is claimed is:

1. A composition comprising
a) at least one prepolymer containing at least one hydrolysable silane group, wherein the prepolymer is selected from silane-modified polyoxyalkylenes, polyolefins, poly-(meth)acrylates, polyurethanes, polyamides or polysiloxanes, and
b) at least one Sn-based catalyst,
wherein the Sn-based catalyst is selected from tetramethyl-stannoxy dicarboxylates.

2. The composition according to claim 1, characterized in that the prepolymer is selected from polyoxyalkylenes, and/or poly(meth)acrylates containing at least two crosslinkable silane groups.

3. The composition according to claim 1, characterized in that the composition comprises besides the tetramethyl-stannoxy dicarboxylate at least one further catalyst, in particular an amine-, amidine- or guanidine catalyst.

4. The composition according to claim 1, characterized in that the composition further comprises c) at least one adjuvant.

5. The composition according to claim 1, characterized in that the tetramethyl-stannoxy dicarboxylate is selected from tetramethyl-stannoxy dilaurate, tetramethyl-stannoxy dioleate, and mixtures thereof.

6. The composition according to claim 1, characterized in that the hydrolysable silane group of the prepolymer is a trialkoxy-silane group or alkyldialkoxy-silane group, in particular of C₁₋₄-alkanoles.

7. The composition according to claim 4, characterized in that the adjuvant is selected from resins, softeners, stabilizers, pigments or fillers, or thickeners.

8. The composition according to claim 1, characterized in that the composition is a 2 component composition, comprising a first component A and a second component B, wherein said component A contains the at least one prepolymer with hydrolysable silane groups, and said component B contains the catalyst and in addition at least one compound selected from the group consisting of water, water-absorbing fillers, other silane-crosslinking prepolymers and/or monomeric silane compounds.

9. The composition according to claim 8, characterized in that component B contains water.

10. Composition according to claim 1, characterized in that the composition is a 1 component composition and is crosslinking by moisture.

11. Composition according to claim 1, characterized in that the composition comprises 0.01 to 5 wt.-% of the Sn-based catalyst based on the total weight of the composition.

12. Use of a tetramethyl-stannoxy dicarboxylate as a catalyst for crosslinking silane-hardening compositions selected from one component and two component adhesives, sealants and coatings.
